(19) United States
(12) Patent Application Publication
(10) Pub. No.: US 2011/0013008 A1
(43) Pub. Date: Jan. 20, 2011

(54) DEVICE FOR ACQUIRING IMAGE OF LIVING BODY

(76) Inventors: Shinji Nagamachi, Kyoto (JP); Yoshio Tsunazawa, Kyoto (JP); Ichiro Oda, Kyoto (JP)

Correspondence Address: Cheng Law Group, PLLC, 1100 17th Street, N.W., Suite 503, Washington, DC, 20036, US

(21) Appl. No.: 12/515,010

(22) PCT Filed: Nov. 16, 2006
(86) PCT No.: PCT/JP2006/322826

§ 371 Date: Jan. 13, 2010

(51) Int. Cl. H04N 7/18

(52) U.S. Cl. 348/79

(57) ABSTRACT

Observation of a living body sample from multiple directions can be measured in a short time and with a convenient structure. One two-dimensional detector is arranged in order to pick up the image of light emitted from a sample on a sample holder, and connected with a display for displaying the image picked up by means of the two-dimensional detector. In order to observe the sample on the sample holder from a plurality of directions and to introduce the image of light emitted from the sample in each direction to the two-dimensional detector, a light guide optical system including a multi-reflector assembly consisting of reflectors is provided. A main image formation lens for forming on the two-dimensional detector a plurality of images introduced by the light guide optical system is arranged between the two-dimensional detector and the light guide optical system. Auxiliary image formation lenses for correcting according to a light path length difference an image formed on the two-dimensional detector a main image formation lens is arranged between the main image formation lens and the light guide optical system.

### TECHNICAL FIELD

The present invention relates to an optical bioimaging technique for living body samples such as small animals.

### BACKGROUND ART

A technique for imaging the distribution of molecular species in a living body is an important tool used in medical and biological research. Imaging of molecular species at the cellular level has been widely performed using a microscope and a molecular probe such as a molecular probe labeled with a fluorescence pigment or a chemiluminescence molecular probe. However, recently, there is a growing demand for devices for observing in vivo the distribution of molecular species of interest at the organ or whole-body level rather than the cellular level. For example, such an observation device allows the imaging of the distribution of target cancer cells labeled with a fluorescence probe in the body of a small living animal, such as a mouse, to monitor the growth of the target cancer cells over a fixed period of time, such as every day or every week. In a case where the growth of cancer cells in the body of an animal is monitored using a conventional device for cellular-level imaging, the animal is killed to stain or fluorescently-label cancer cells in a predetermined part of the body of the animal. In this case, the growth of cancer cells in the same individual cannot be monitored over a long period of time. For this reason, there is a demand for the development of a device capable of observing the distribution of molecular species in the body of a small living animal to obtain internal information about the body of the small animal.

Near-infrared light can relatively easily pass through a living body, and therefore, devices for observing small animals generally use light having a wavelength in the range of about 650 to 900 nm. However, a conventional observation method has a problem in that a sample cannot be observed from multiple directions simultaneously. Therefore, for example, there is a case where when a mouse is observed from a certain direction, cancer is not detected, but when the mouse is observed from the opposite direction, cancer is detected. In a case where a mouse is observed using a device which can observe a sample from only one direction, an operator has to, by necessity, observe the mouse approximately from multiple directions by picking up images from different angles by rotating the mouse in small-angular increments about the body axis of the mouse. However, reproducible data cannot be obtained by such a method, and simultaneous detection from different directions cannot be achieved.

As another method for acquiring images picked up from multiple directions, a method in which images picked up from multiple angles are successively acquired in a time-division manner by using a rotating reflector is known (see US Patent Application No. 20050201614). According to this method, the sample can be observed from multiple directions by rotating a mirror during observation, without rotating the sample or a two-dimensional detector, but with slight parrarel sample movement.

### DISCLOSURE OF THE INVENTION

### Problem to be Solved by the Invention

However, the method using a rotating reflector disclosed in US Patent Application No. 20050201614 is disadvantageous in that a sample is observed from different directions not simultaneously but in a time-division manner, and therefore, it takes a lot of time to observe the sample and, in addition, the structure of a device for carrying out the method becomes complicated. It is therefore an object of the present invention to provide a living body imaging device which has a simple structure and which can observe a living body from multiple directions simultaneously in a short time.

### Means for Solving the Problem

As a method for observing a sample from multiple directions, a method in which the images of light emitted from a sample in multiple directions are formed on a common two-dimensional detector by a common image formation lens can be mentioned. That is, the living body image acquiring device of the present invention includes a sample holder for placing a living body sample thereon; one two-dimensional detector for picking up an image of light emitted from a sample placed on the sample holder; an image display device for displaying an image picked up by the two-dimensional detector;

a light guide optical system for observing a sample placed on the sample holder from multiple directions and guiding images of light emitted from the sample in different directions to the two-dimensional detector; and one main image formation lens provided between the two-dimensional detector and the light guide optical system to form a plurality of images guided by the light guide optical system on the two-dimensional detector.

An example of the light emitted from a sample is fluorescence emitted from a sample irradiated with excitation light. Another example of the light emitted from a sample is chemiluminescence or bioluminescence emitted from a sample itself without irradiation with excitation light.

The light guide optical system may include a multi-reflector assembly having two or more reflectors for reflecting images of a sample observed from different directions and guiding the images to the two-dimensional detector. More specifically, light beams emitted from a sample in multiple directions covering 360° are bent by the multi-reflector assembly and guided to different positions on the common two-dimensional detector. A reflector for bending light is generally used as a light guide optical system having the function of guiding light beams emitted in different directions to several positions spaced at appropriate intervals on one detector.

When a multi-reflector assembly is used, differences in focus positions of an image formation lens generally arise for respective light paths. Insertion of a reflector generally increases light path lengths and changes the focusing point, therefore, focus correction is performed by inserting auxiliary image formation lenses having different curvatures into the light paths of light beams emitted in respective directions. That is, in a preferred embodiment of the present invention, the light guide optical system includes light paths different in light path length from a sample to the main image formation lens, and at least one light path of the light guide optical system has an auxiliary image formation lens for correcting, according to a light path length difference, an image formed on the two-dimensional detector by the main image formation lens. An example of the auxiliary image formation lenses is a mosaic lens for different fields of view provided on the light paths of the light guide optical system, respectively. Insertion of appropriate auxiliary image formation lenses such as a mosaic lens eases restrictions on the layout of the light guide optical system, thereby making it possible to relatively flexibly design the bending of light beams. In this way, light beams emitted from a sample in multiple directions can be introduced into the common detector, and therefore, the sample can be observed from multiple directions simultaneously in a short time. Further, an observation device having no moving parts can be achieved. As will be described later, the auxiliary image formation lens for focus correction can have a small curvature (i. e. , a long focal length), and therefore, a single lens such as an eyeglass is sufficiently effective as the auxiliary image formation lens, which prevents the observation device from having a complex structure.

The present invention will be more specifically described with reference to FIG. 1 showing a typical embodiment of the present invention. As shown in FIG. 1, a small animal (typically, a mouse) used as a sample 10 is placed at the center and observed from five different angles, and images are formed on a common two-dimensional detector 14 by a common image formation lens L located above the sample 10. Light beams other than a light beam emitted in a 0°-direction, that is, light beams emitted in different observation directions forming angles of 72°, 144°, 216°, and 288° with respect to the 0°-direction are reflected by reflectors M2 to M5 and introduced into the image formation lens L so that images are formed on the common two-dimensional detector 14.

The images formed on the two-dimensional detector 14 are shown in FIG. 2. As shown in FIG. 2, these five images correspond to, from right to left, images observed from the 72°-direction, 144°-direction, 0°-direction (center), 216°-direction, and 288°-direction, respectively. The image observed from the 0°-direction arranged at the center is the largest because the light beam emitted in the 0°-direction is not reflected by a reflector, and therefore, the distance to the image formation lens is the shortest. On the other hand, the other four images are smaller in size than the image observed from the 0°-direction because the light beams emitted in the 72°-direction, 144°-direction, 216°-direction, and 288°-direction are reflected by the reflectors M2 to M5, and therefore, the distances from the virtual images of the sample 10 are longer than the distance from the sample 10. In addition, these four images (72°, 144°, 216°, and 288°) are horizontally inverted. For these reasons, such images as shown in FIG. 2 are formed on the two-dimensional detector 14. In this case, there is a problem that the light paths of the five light beams have different distances (light path lengths) due to the use of the reflectors M2 to M5, and therefore, unfocused images are formed on the two-dimensional detector 14. However, such a problem can be solved by inserting auxiliary image formation lenses L1, L2, L3, L4, and L5 into the light paths of the five light beams, respectively. The auxiliary image formation lenses L1 to L5 have different focal lengths corresponding to the light path lengths of the light paths of the five light beams. In the case of this embodiment, the auxiliary image formation lenses L3 and L4 inserted into the light paths of the light beams emitted in the 144°-direction and the 216°-direction having the longest light path length are plane-parallel flat plates having no curvature. On the other hand, the auxiliary image formation lens Li inserted into the light path of the light beam emitted in the 0°-direction having the shortest light path length is a convex lens, and the auxiliary image formation lenses L2 and L5 inserted into the light paths of the light beams emitted in the 72°-direction and the 288°-direction having a light path length intermediate between the longest and shortest light path lengths are convex lenses of which curvature is smaller (i. e. , whose focal length is longer) than that of the auxiliary image formation lens L1. That is, the auxiliary image formation lenses L1, L2, L3, L4, and L5 constitute, as a whole, a mosaic lens whose focal length is different from portion to portion. As described above, this embodiment achieves a simple structure having no moving parts and the formation of images of a sample observed from different angles on the common two-dimensional detector 14 at one time.

The image display device can display images obtained by subjecting images formed on the two-dimensional detector to correction for a size difference resulting from a difference in light path length between the light paths of the light guide optical system. The image display device can also display image information obtained by changing the orientation and sequence of images formed on the two-dimensional detector.

It is preferred that the light guide optical system allows a sample placed on the sample holder to be observed from four or more evenly spaced directions covering 360° around the sample.

In a preferred embodiment, the main image formation lens and the two-dimensional detector are placed in one direction perpendicular to the axial direction of a sample and each of the reflectors of the light guide optical system has a plane containing a straight line parallel to the axial direction of a sample as a reflection plane.

In another preferred embodiment, the main image formation lens and the two-dimensional detector are placed on an extended line of the axis of a sample, and the reflectors are arranged so that the principal rays emitted from the sample in different directions lie in n evenly divided planes (n is an integer of 3 or more) of which central axis is the axis of the sample.

Further, another modified example will be described. That is, in either case where the main image formation lens and the two-dimensional detector are placed in one direction perpendicular to the axial direction of a sample or a case where the main image formation lens and the two-dimensional detector are placed on an extended line of the axis of a sample, a device for controlling image pickup operation can be added to observe a sample from n evenly spaced directions and the controlling device can rotate the detector and the image formation lens relative to the sample in increments of an angle of 1/(n×m) of 360° (m is an integer of 2 or more) around the sample to perform an operation of acquiring images of the sample observed from n evenly spaced directions m times every 1/(n×m) of 360-degree rotation so that images observed from n×m evenly spaced directions covering 360° are acquired.

When the living body image acquiring device acquires a fluorescence image as an image of the light emitted from a sample, an excitation optical system for irradiating the sample with excitation light to generate fluorescence may be placed in a space between light paths of the light guide optical system. The excitation optical system preferably includes, as excitation light sources, light-emitting devices, each having a laser diode or a light-emitting diode. In such a case, the irradiation direction of a sample with excitation light can be changed by changing the lighting on/off pattern of the light-emitting devices. Further, each of the excitation light sources of the excitation optical system may have two or more light-emitting devices emitting light of different wavelengths, and each of the light-emitting devices may have an interference filter to remove an unnecessary wavelength component that might be incidentally included in the excitation light sources. In this case, it is possible to change the wavelength of excitation light by selecting the lighting on/off pattern of the light-emitting devices.

### Effect of the Invention

The living body image acquiring device according to the present invention can easily and simultaneously obtain the images of a living body sample observed from multiple directions covering 360° around the sample because the light guide optical system guides the images of light emitted from the living body sample in different directions to the common two-dimensional detector through the common main image formation lens.

### BRIEF DESCRIPTION OF THE DRAWINGS

FIG. 1 is a schematic perspective view of one embodiment of the present invention.

FIG. 2 is a plan view showing images formed on a two-dimensional detector of the embodiment shown in FIG. 1.

FIG. 3 is an elevation view of the embodiment shown in FIG. 1, seen from the axial direction of a sample.

FIG. 4 is a perspective view of one excitation light source of the embodiment shown in FIG. 1.

FIG. 5 is a plan view for explaining the operation of converting images formed on the two-dimensional detector into images displayed on a display device.

FIG. 6 is an elevation view of another embodiment of the present invention, seen from the axial direction of a sample.

FIG. 7 is a plan view showing images formed on a two-dimensional detector of the embodiment shown in FIG. 6.

FIG. 8 is a plan view showing images formed on a two-dimensional detector of another embodiment of the present invention.

FIG. 9 is a perspective view of another embodiment of the present invention.

FIG. 10 is a development view showing the images of a sample reflected in reflectors of the embodiment shown in FIG. 9, seen from the image formation lens side.

### DESCRIPTION OF THE REFERENCE NUMERALS

10 living body sample

14 two-dimensional detector

20 light source mounting base

M2 to M5, M2′ , R1 to R8 reflectors

L main image formation lens

L0 to L5 auxiliary image formation lenses

S1 to S5 excitation light sources

F_{EM} fluorescence filter

LDλ1A, LDλ1B, LDλ2A, LDλ2B laser diodes

Fexλ1A, Fexλ1B, Fexλ2A, Fexλ2B excitation light filters

### DETAILED DESCRIPTION OF THE INVENTION

### <First Embodiment>

(Description of Method for Simultaneous Observation from Five Directions)

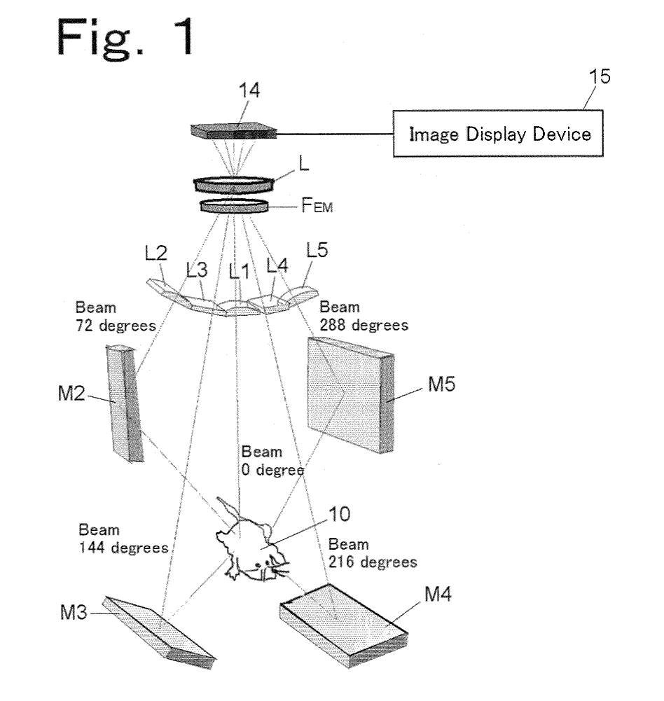

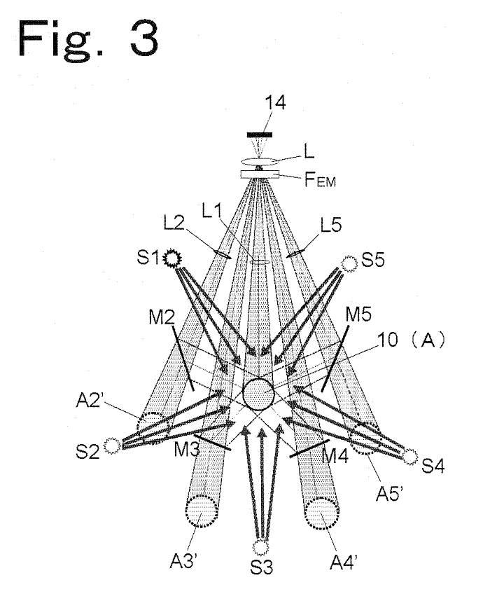

Simultaneous observation from five directions will be described by way of example with reference to FIGS. 1 and 3. Hereinbelow, simultaneous observation from five directions in chemiluminescence mode or bioluminescence mode will be described.

FIG. 1 is a schematic view showing the structure of one embodiment of the present invention. In the embodiment shown in FIG. 1, a sample is observed from five directions evenly spaced around the sample. It is to be noted that a mouse, which is a small animal, is used as a living body sample 10, but the living body sample 10 is not limited thereto. The sample 10 is placed on a sample holder (not shown). One two-dimensional detector 14 is provided to pick up the image of light emitted from the sample 10 placed on the sample holder. Examples of the two-dimensional detector 14 include a CCD image pickup device and a MOS-type image sensor. Although not shown in FIG. 1, an image display device is connected to the two-dimensional detector 14 to display an image picked up by the two-dimensional detector 14. A light guide optical system including a multi-reflector assembly having reflectors M2 to M5 is provided to observe the sample 10 placed on the sample holder from a plurality of directions and to guide the images of light emitted from the sample 10 in different directions to the two-dimensional detector 14. Between the two-dimensional detector 14 and the light guide optical system, a camera lens is provided as one main image formation lens L for forming images guided by the light guide optical system on the two-dimensional detector 14.

The main image formation lens L and the two-dimensional detector 14 are placed in one direction perpendicular to the direction of the axis (in a case where the sample 10 is a small animal, the body axis extending from its head to tail) of the sample 10 placed on the sample holder. The reflectors M2 to M5 of the light guide optical system are arranged in five directions evenly spaced around the sample 10 so that each of the reflectors M2 to M5 has a plane containing a straight line parallel to the axial direction of the sample 10 as a reflection plane.

As described above, the light guide optical system includes the reflectors M2 to M5, and therefore has light paths different in light path length from the sample 10 to the main image formation lens L. Therefore, an auxiliary image formation lens for correcting, according to a light path length difference, an image formed on the two-dimensional detector 14 by the main image formation lens L is provided between the main image formation lens L and the light guide optical system on at least one light path of the light guide optical system. In the embodiment shown in FIG. 1, auxiliary image formation lenses L1 to L5 are provided. The auxiliary image formation lenses L1 to L5 have different focal lengths corresponding to the light path lengths of the five light paths of the light guide optical system, and constitute a mosaic lens for different fields of view.

The point of this embodiment has been already described in “MEANS FOR SOLVING THE PROBLEM” with reference to FIG. 1, but will be further described in more detail with reference to FIG. 3. As shown in FIG. 3, light beams emitted from the sample 10 (A) in different observation directions forming angles of 72°, 144°, 216°, and 288° with respect to the 0°-direction are reflected by the reflectors M2 to M5, respectively, so that virtual images A2′, A3′ A4′, and A5′ of the sample 10 are formed by the reflectors M2 to M5. The images of these virtual images A2′ to A5′ are formed on the common two-dimensional detector 14 by the image formation lens L located above the sample 10. The sample 10 is, for example, a mouse which is a small animal, but is shown as a cylindrical article in FIG. 3 for the sake of brevity.

The images A, A2′, A3′, A4′, and A5′ can be seen in five directions below the image formation lens L. In this case, the image A is a real image and the other four images A2′, A3′, A4′, and A5′ are virtual images. As can be seen from FIG. 3, the distances to the images A3′ and A4′ are the longest, the distance to the front real image A is the shortest, and the distances to the images A2′ and A5′ are intermediate between the longest and shortest distances. In the case of the embodiment shown in FIG. 3, when the image formation lens L is focused on the images A3′ and A4′, unfocused images of the images A1, A2′ and, A5′ are formed on the two-dimensional detector 14. Therefore, the auxiliary image formation lenses (convex lenses) L2 and L5 are used to correct the images of the images A2′ and A5′ formed on the two-dimensional detector 14, and the auxiliary image formation lens (convex lens) L1 is used to correct the image of the image A formed on the two-dimensional detector 14.

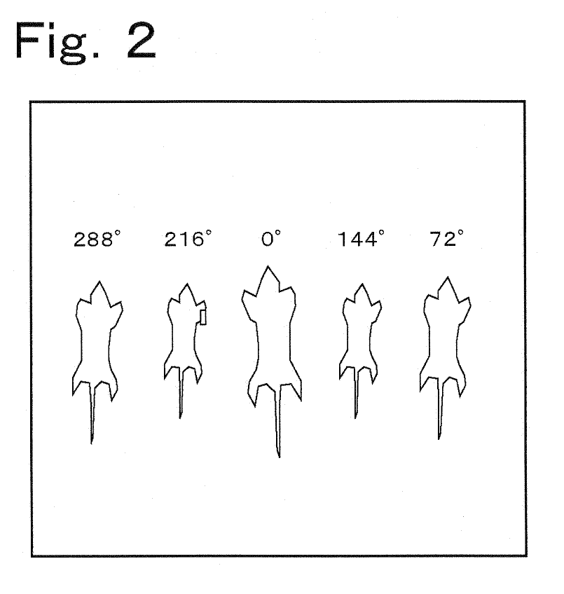

As shown in FIG. 2, five images formed on the two-dimensional detector 14 correspond to, from right to left, the image A2′ (72°), the image A3′) (144°), the image A (0°) (center), the image A4′ (216°, and the image A5′ (288°, respectively. As described above, since the images A, A2′, A3′, A4′, and A5′ are obtained by observing the sample 10 from different angles, the images formed on the two-dimensional detector 14 are different in magnification depending on the distance from the real or virtual image (i.e., A, A2′, A3′, A4′, or A5′) to the lens L. Further, the images corresponding to the images A2′, A3′, A4′, and A5′ are horizontally inverted. For these reasons, such images as shown in FIG. 2 are formed on the two-dimensional detector 14.

A typical focal length of the image formation lens L is about 15 to 20 mm (for example, when the distance from the image formation lens L to the virtual image A3′ of the sample 10 is 300 mm and the magnification of the image of the sample 10 formed on the two-dimensional detector 14 is 1/15, the distance between the center of the image formation lens L and the two-dimensional detector 14 becomes 20 mm, which is calculated by multiplying 300 mm by a magnification of 1/15, and therefore, the focal length of the image formation lens L is a little less than 20 mm). On the other hand, a typical focal length of each of the auxiliary image formation lenses L1, L2, and L5 determined by calculation is about 500 mm to 1500 mm. The reason for this is as follows. Let us define the distance between the sample 10 and the lens L as “a” , and the distance between the virtual image A3′ and the lens L as “b”. The focal length of the auxiliary image formation lens L1 (defined as “f”) is determined so that the light from the distance “a” (for example, “a”=200 mm), proceeds as if it comes from the distance “b” (for example, “b”=300 mm), i.e., the distance 200 mm is transformed to the distance 300 mm by the lens L1. So the focal length “f” can be determined by the following simple image formation formula: (1/f)=(1/a)−(1/b). In this case, the focal length “f” determined by this image formation formula is 600 mm. On the other hand, the focal length of the auxiliary image formation lens L2 (L5) is set so that a distance between the virtual image A2′ (A5′) and the lens L of about 250 mm is transformed to 300 mm which is the distance between the virtual image A3′ and the lens L. Therefore, after the similar calculation, the focal length of the lens L2 (L5) becomes 1500 mm, which is much longer than that of the lens L1. As described above, lenses having focal lengths longer than that of the lens L, that is, lenses having extremely small curvatures suffice as the auxiliary image formation lenses L1, L2, and L5.

It is to be noted that, in this embodiment, the lens L is focused on the farthest images A3′ and A4′, and therefore, it is not necessary to provide auxiliary image formation lenses for the images A3′ and A4′. Alternatively, a simple plane-parallel glass plate may be placed instead of an auxiliary image formation lens at the position of each of the auxiliary image formation lenses L3 and L4.

The image formation lens L may be focused on the position of intermediate distance between the image A and the images A3′ and A4′, ie., on the vicinity of the images A2′ and A5′. In this case, weak concave lenses having a long focal length of about 1000 mm may be used as auxiliary image formation lenses for the images A3′ and A4′, and a weak convex lens having a focal length of about 1000 mm may be used as an auxiliary image formation lens for the front real image A.

According to this embodiment described above, it is possible to achieve a simple structure having no moving parts and to form images observed from different angles on the common two-dimensional detector 14 at one time.

(Description of Observation in Fluorescence Mode)

The above description illustrates observation in chemiluminescence mode or bioluminescence mode in which a sample containing a molecular probe which itself emits light is observed. Hereinbelow, a method for applying the first embodiment of the present invention to fluorescence mode in which a sample containing a molecular probe which emits fluorescence by irradiation with excitation light is observed will be described.

In the case of such fluorescence mode, as will be described later, the method using the multi-reflector assembly used in the present invention has an advantage in that positions for placing light sources for fluorescence excitation can be easily provided. Referring to FIG. 3 again, the effect of such an advantage will be described. FIG. 3 is an elevation view of the embodiment shown in FIG. 1. In FIG. 3, light sources S1 to S5 for fluorescence excitation not shown in FIG. 1 are shown. These five light sources are placed around the sample 10 so that the sample 10 is irradiated with light from five different angles. In this case, there is an advantage that there exist, among the reflectors M2, M3, M4 and M5, proper spaces to be assigned to the excitation light sources S1 to S5.

In the case of observation from five directions evenly spaced around the sample 10, the real image A and the virtual images A2′, A3′, A4′, and A5′ of the sample 10 are formed every 72°, and therefore, excitation light with which the sample 10 is irradiated forms an angle of +36° or −36° with a principal ray emitted from the sample and traveling directly toward the lens L1 or toward the center of the reflector M2, M3, M4, or M5. In the case of observation from six or seven directions evenly spaced around the sample 10, the angle which the direction of excitation light forms with the principal ray is ±30° or ±25. 714°, respectively, which is an irradiation angle suitable for measuring fluorescence.

In the case of fluorescence measurement, the wavelength of excitation light emitted from the light sources S1 to S5 is usually selected according to the absorption wavelength of a fluorescence probe having specificity to a molecular species or a tumor of interest. A fluorescence filter F_{EM} is provided just before the image formation lens L to detect only the wavelength component within the spectral pass band of the F_{EM}, separating from all the fluorescence light that comes from the sample 10 by irradiation with excitation light.

If some parts of the wavelength components of excitation light leak through the filter after being scattered with their wavelengths unchanged and then are detected, such wavelength components become background light and interfere with observation. Therefore, the selection of the wavelength of excitation light emitted from the light sources S1 to S5 and the selection of the transmission characteristics of the fluorescence filter F_{EM} are important to completely prevent the passage of wavelength components of the excitation light through the fluorescence filter F_{EM}.

In a case where semiconductor lasers are used as the excitation light sources S1 to S5, only the necessary light source (s) can be freely turned on and off by switching on and off their respective power supply circuits.

In this case, there are some choices of the lighting pattern of excitation light to excite fluorescence to observe the sample 10 from a plurality of angles over 360°. Hereinbelow, these choices will be described with reference to the case of observation from five directions described above.

A first choice is to turn on all the excitation light sources S1 to S5 at the same time. More specifically, five images which appear on the two-dimensional detector 14 as shown in FIG. 2 are picked up and recorded in a state where the sample 10 is always irradiated with excitation light from five directions covering 360°.

A second choice is as follows. Five images are picked up by the two-dimensional detector 14 in a state where a pair of two angularly adjacent excitation light sources (S1 and S2) out of the five excitation light sources S1 to S5 is turned on and the remaining three excitation light sources are turned off, and then five images are further picked up in a state where another pair of two adjacent excitation light sources (S2 and S3) is turned on and the remaining three excitation light sources are turned off, and such an operation is repeated changing the combination of two adjacent excitation light sources in turn, and finally, five images are picked up in a state where the final pair of two adjacent excitation light sources (S5 and S1) is turned on and the remaining three light sources are turned off.

Thus obtained pictures that contain 25 (5 different view×5 different irradiation angle) images include many fluorescence images with irradiation of, front direction or back direction or side direction and so on. Therefore summarizing once again, 25 images can be obtained in total by performing exposure 5 times because each of the five images picked up from five different directions around the animal has five variations picked up by changing the irradiation direction of the sample with excitation light.

From the 25 images, it can be estimated whether the depth of a fluorescence source present in the body of the animal is shallow or deep. More specifically, when a fluorescence source is present at a shallow depth, it can be supposed that a small extremely-bright spot appears in any one of the 25 images of the subject, and on the other hand, when a fluorescence source is present at a deep depth, it can be supposed that widely diffused light distribution appear in all the 25 images. In addition, the original distribution of a fluorescent material can be imaged by inverse operation using an appropriate algorithm.

A third choice is as follows. Five images are picked up in a state where one of the excitation light sources S1 to S5 is turned on and the remaining light sources are turned off, and then such an operation is repeated 4 times by changing the light source to be turned on in turn. Therefore, exposure is performed 5 times. The third choice is very similar to the second choice and becomes equivalent to the second choice if the principle of image superposition holds. When the above principle holds (i.e., the third choice is equivalent to the second choice), the second choice is more advantageous from the viewpoint of S/N ratio because the intensity of excitation light is higher. On the other hand, when the third choice is not equivalent to the second choice, both the second and third choices may be implemented. In this case, 50 images are obtained by 10 times exposure, and calculation for imaging the original distribution of a fluorescent material can be performed using these data. If necessary, other various lighting on/off patterns of the excitation light sources can be achieved.

The important point is that the fluorescence excitation method used in the present invention requires no moving parts, and therefore, can be flexibly changed simply by changing the lighting on/off pattern of excitation light so that the sample is irradiated with excitation light from the front, side, or back thereof. Therefore, observed images of the sample excited from different directions covering 360° can be easily obtained even in the case of fluorescence mode.

(More Detailed Description of Examples of Fluorescence Excitation Light Source)

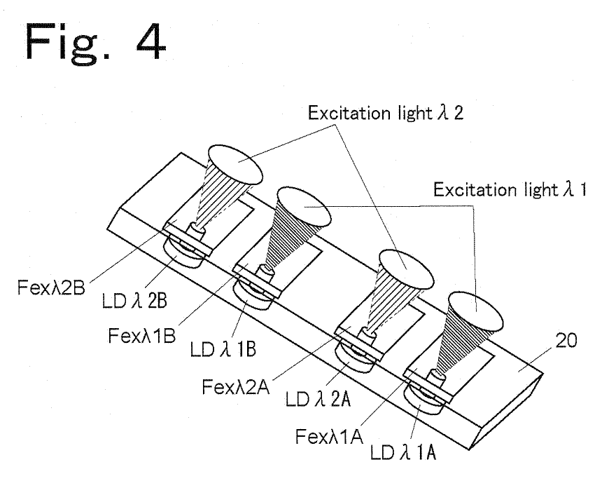

Amore specific example of the fluorescence excitation light source to be used in the present invention such as the light sources S1 to S5 shown in FIG. 3 will be described with reference to FIG. 4.

The four requirements of the fluorescence excitation light source are as follows: (1) light having a wavelength suitable for exciting a target fluorescence pigment can be produced; (2) excitation light contains no spectral energy in the spectral pass band of the filter for fluorescence detection (e. g. , the filter F_{EM} shown in FIG. 1) (i. e., excitation wavelengths are completely separated from fluorescence wavelengths); (3) the entire small animal as a sample can be irradiated with excitation light as uniformly as possible; and (4) the position (s) of the necessary light source (s) and the wavelength of excitation light can be flexibly selected.

FIG. 4 shows an example of the structure of any one of the light sources S1 to S5 shown in FIG. 3. As shown in FIG. 4, four laser diodes LDλ1A, LDλ2A, LDλ1B, and LDλ2B are mounted on a light source mounting base 20. The light source mounting base 20 is a long plate-shaped holder extending in a direction parallel to the body axis of the small animal, and the four laser diodes are arranged in the body axial direction of the small animal. In this example, two of the four laser diodes (i. e. , LDλ1A and LDλ1B) emit the same wavelength (e. g., 780 nm), and the remaining two laser diodes (1. e. LDλ2A and LDλ2B) emit another wavelength (e. g., 690 nm). The laser diodes emitting the same wavelength are spaced apart from each other.

Further, excitation light filters Fexλ1A, Fexλ2A, Fexλ1B, and Fexλ2B are attached to the four laser diodes, respectively. Therefore, pairs of one laser diode and one filter, i. e., (LDλ1A and Fexλ1A) , (LDλ2A and Fexλ2A) , (LDλ1B and Fexλ1B) , and (LDλ2B and Fexλ2B) each emit excitation light toward the sample. In general, a semiconductor laser emits one fixed wavelength, and therefore, it is often assumed that a semiconductor laser can sufficiently perform its function (i.e., excitation) by itself. However, when examined in more detail, excitation light emitted from a semiconductor laser often contains not only a main laser emission wavelength but also a broad and weak spectrum appearing at the foot of the main peak of laser emission. If some part of the weak light component passes through the fluorescence filter, it is detected as leaked light. It has been found that such a leaked light component contained in excitation light and overlapping with fluorescence can be reduced to a very low level by adding a suitable interference filter to an original laser diode. The interference filters Fexλ1A, Fexλ2A, Fexλ1B, and Fexλ2B are added to the laser diodes for this purpose. In the situation where the five light sources (S1 to S5) of the above structure are arranged around the sample, selection of the position(s) of necessary light source(s) and the wavelength of excitation light can be flexibly performed simply by electrically selecting (i. e. , by turning on) only the necessary laser diode(s) from the 20 laser diodes (4 laser diodes/one light source×5 light sources S1 to S5).

In the above-described case, each of the light sources S1 to S5 has two wavelengths, but as a matter of course, more laser diodes having different wavelengths may be provided if space permits. Further, the laser diode and the excitation light filter are mechanically fixed to each other. Therefore, it is very easy to design an appropriate mechanical light shield (not shown) that prevent the occurrence of light leakage through a gap between the laser diode and the filter, at the same time ensuring the necessary light emitted from the laser diode always pass through the filter.

In a case where the excitation light source has such a structure as described above, the wavelength of excitation light and the wavelength of fluorescence to be detected are selected in the following manner. The lighting on/off pattern of the five excitation light sources and the wavelength of excitation light are selected by an electric method, and the fluorescence filter F_{EM} shown in FIG. 1 is selected from among two or more kinds of fluorescence filters F_{EM} attached to a rotating disk. Summarizing above, the invention proposes a very simple fluorescence system that achieves multi-directional excitation and multi-directional detection with only one mechanical moving part remained as the a rotating disk for the fluorescence filter F_{EM} . No other moving parts are necessary for the excitation side.

(Conversion from Images on Two-Dimensional Detector to Images on Display Device)

As described above, images observed from different angles are formed on the common two-dimensional detector 14, but there are problems that these images are different in magnification and are not arranged in proper sequence and some of these images are horizontally inverted by the mirrors. However, as shown in FIG. 5, these images can be subjected to corrections for magnification and horizontal inversion and rearranged in proper sequence by performing simple transformations and then finally displayed on a display screen.

In addition to the bioluminescence or fluorescence images of molecular species, the photographs of appearance of the sample can also be taken by the same two-dimensional detector 14 to superpose the images of molecular species onto the photographs. Image correction of different magnifications, left/right inversion and image order adjustment can be similarly achieved by performing transformations in the same manner as shown in FIG. 5 to finally display the images of molecular species superposed on the photographs of appearance of the sample taken from multiple directions in proper sequence.

(Description of Modified Examples of First Embodiment)

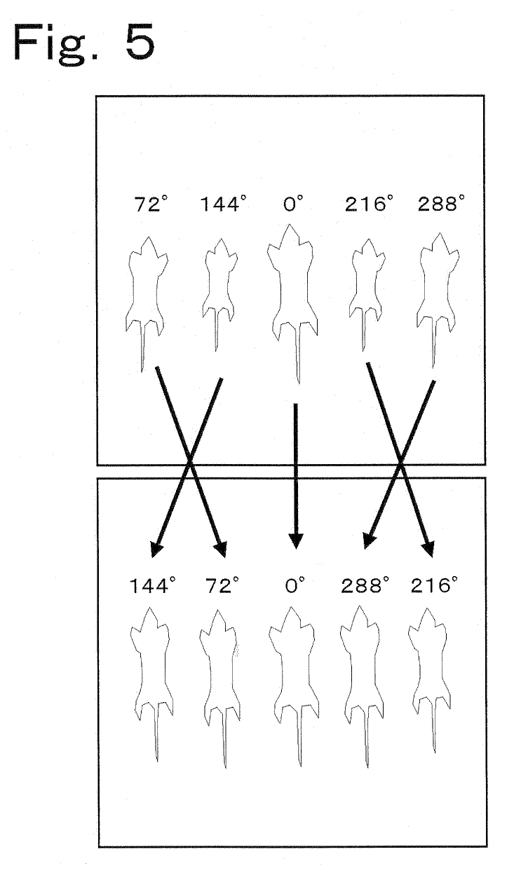

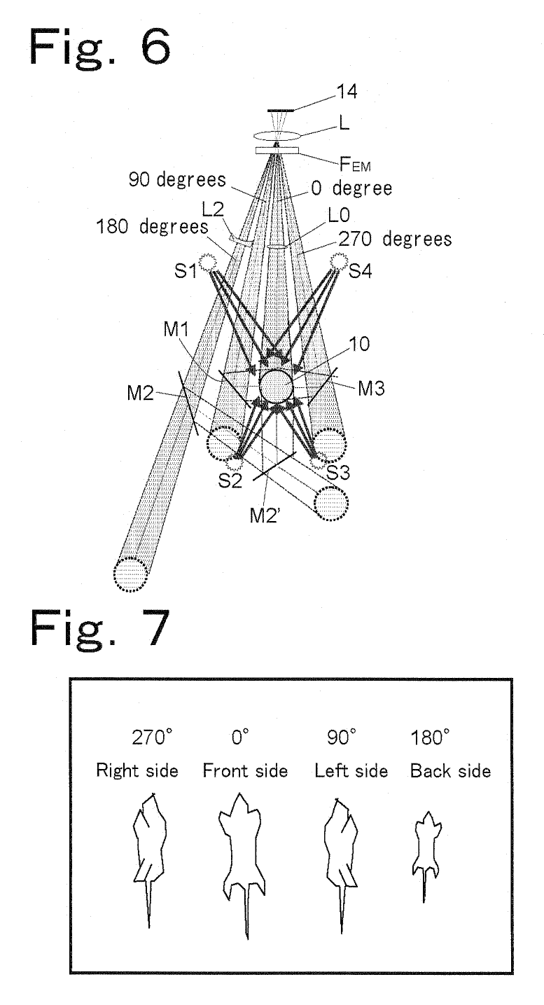

In the above description, observation from five evenly spaced directions has been explained. Hereinbelow, observation of four evenly spaced directions will be described with reference to FIGS. 6, 7, and 8. The observation of four evenly spaced directions is advantageous in that it can be sensuously grasped by humans because an observer can easily image observation directions, e.g., a front-side view (0′) , a left-side view (90°), a back-side view (180°), and a right-side view (270°.

FIG. 6 shows one example of observation of four evenly spaced directions. As shown in FIG. 6, a mirror M1 for the left-side view) (90°) and a mirror M3 for the right-side view (270°) are provided on bothsides of the front-side view (0°). For the remaining back side view (180°, another two mirrors M2′ , M2 are provided forming the image for 180°, after two successive reflections, at the position next to the image for 90° on the two-dimensional detector. FIG. 7 shows images formed on the two-dimensional detector 14. As shown in FIG. 7, the image for the right-side view (270°) and the image for the left-side view (90°) are arranged on both sides of the image for the front-side view (0°), and the image of the back-side) view (180°) is arranged on the extreme right. The image for the right-side view (270°) and the image for the left-side view (90°) are slightly smaller than the image of the front-side view (0°), and the image of the back-side view (180°) is much smaller than the image for the front-side view (0°).

Referring to FIG. 6 again, auxiliary image formation lenses will be described. In this example, the lens L is focused on the left-side view (90°) and the right-side view (270°) (i. e. , views 90° and 270° do not need an auxiliary image formation lens), while for the 0° view having a shorter path length, a convex lens L0 is provided. Similarly a concave lens is provided for the 180° view having the longest path length. Fluorescence excitation light sources are not always placed every 90° (i. e., at ±45° with respect to the observation directions) depending on the layout of the mirrors. In this example, fluorescence excitation light sources for the front-side view and the back-side view are placed at about ±40° with respect to the observation direction, and fluorescence excitation light sources for the left-side view (90°) and the right-side view (270°) are placed at about ±50° with respect to the observation direction. In addition, the light sources S2 and S3 are placed closer to the sample 10 than the light sources S1 and S4. The distances between the light sources S1 to S4 and the sample 10 do not always have to be the same, and various layouts of the light sources are possible according to the layout of other components such as mirrors.

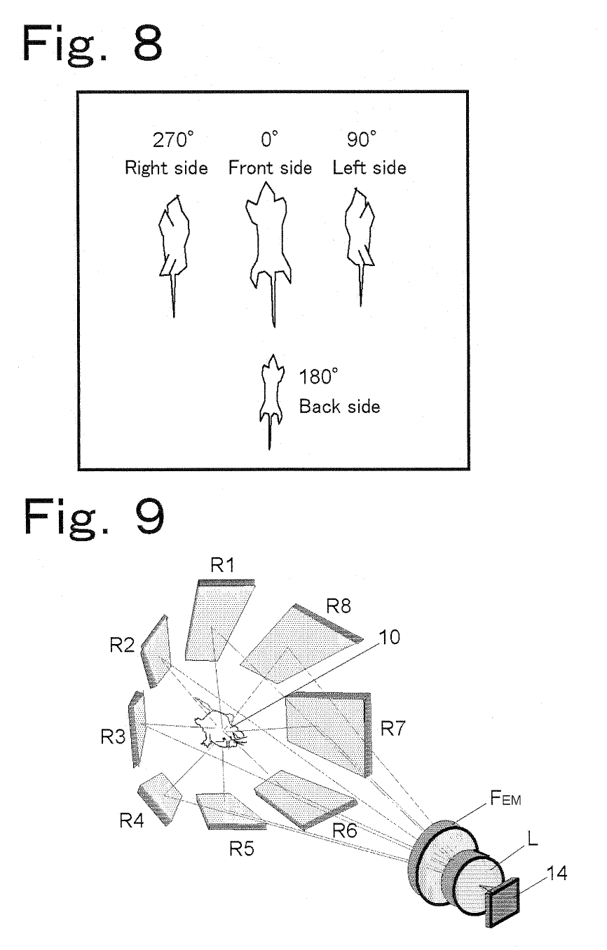

FIG. 8 shows another example of observation of four directions. In this example, image arrangement on the two-dimensional detector is different in the point that the back-side image (180°) is arranged on a row different from the row in which other three images of 0°, 90°, and 270° are aligned. More specifically, the position of the mirror M2 is changed so that a light beam in the 180°-direction are bent by the mirror M2′ in a direction perpendicular to the plane formed by light beams of 0°-, 90° and 270° direction and then travels toward the lens L. This example shows that a change in bending direction of a mirror can expand the flexibility of the layout of, for example, the fluorescence excitation light sources, if the two-dimensional detector is nearly square shaped, because there is no major inconvenience in such image arrangement of as in FIG. 8.

As can be seen from FIGS. 6, 7, and 8, the number of mirrors provided in the light guide optical system is not limited to one, and various changes can be made to the light guide optical system as long as many required images of the sample guided by the light guide optical system can be finally formed on the two-dimensional detector 14. Further, even when the light path lengths of the light paths are changed by changing the light guide optical system, image formation conditions can be easily corrected by inserting appropriate auxiliary image formation lenses into the light paths.

### Second Embodiment

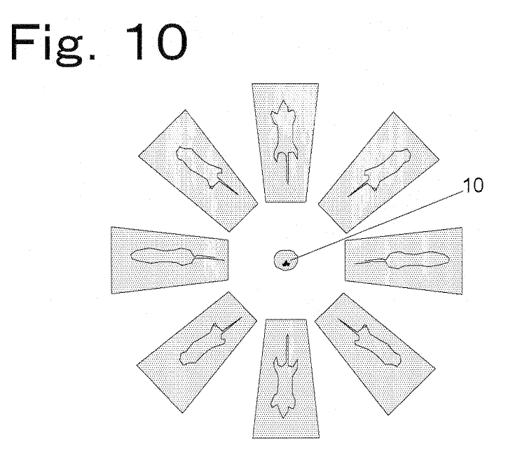

A second embodiment of the present invention will be described with reference to FIG. 9 (a bird' s eye view) and FIG. 10. As described above, in the first embodiment, the image formation lens L is placed in “one direction perpendicular to the body axial direction” of a small animal used as the sample 10. However, in the second embodiment, the image formation lens L and the two-dimensional detector 10 are placed in the “body axial direction” of a small animal as shown in FIG. 9. Further, reflectors are arranged around the body axis of the small animal like an umbrella. In the second embodiment shown in FIG. 9, eight reflectors R1 to R8 are arranged like an umbrella, and therefore images observed from eight different directions separated by 45° can be picked up at the same time.

FIG. 10 is a conceptual diagram showing the images of a small animal used as the sample 10 reflected in the reflectors R1 to R8, seen from the lens L-side. Eight images arranged in a radial fashion can be read from the two-dimensional detector 14. These eight images can be rearranged by data transformation so that an observer can easily observe the images. In the second embodiment, the distances from the lens to the images reflected in the reflectors R1 to R8 placed in different directions are the same, and therefore it is not necessary to provide auxiliary image formation lenses for focus correction. The second embodiment has the disadvantage that the ratio of the area of images of the sample 10 to the area of the two-dimensional detector 14 tends to be smaller than that of the first embodiment, but has the advantage that no auxiliary image formation lenses are required.

The advantages of the first and second embodiments of the present invention can be summarized as follows:

1) A sample can be observed from multiple directions simultaneously by using one two-dimensional detector.

2) A sample can be easily observed from multiple directions, and therefore, even when a sample (e.g., a small animal) has a tumor on its underside that cannot be seen from the observer' s side, the tumor can be detected.

3) In the case of fluorescence observation, positions for placing excitation light sources can be provided without conflict in spaces between reflectors used to observe a sample from multiple directions. Therefore, even in the case of fluorescence observation, a sample can be easily observed from multiple directions.

4) In the case of fluorescence observation, each of the excitation light sources may be formed by attaching a filter to a semiconductor laser or an. LED. In this case, the irradiation direction of a sample with excitation light and the wavelength of excitation light emitted from the excitation light sources can be selected by turning on and off only the necessary excitation light source(s) without using moving parts.

5) For fluorescence observation, combined data of multi-directional excitation and multi-directional observation are obtainable. Full set of these combined data will constitute the basis of reconstructing in-vivo fluorescence imaging. For example, in FIG. 3, the images of the front-side view (0°-direction) can have five different irradiation direction, i.e., from S1, S2 (from front), S3, S4 (from side), S5 (from back).

### Third Embodiment

According to a third embodiment, a sample (or a detection system) is tilted relative to a detection system (or a sample) in increments to obtain data every certain angle close to an angle achieved by continuously tilting the sample (or the detection system) relative to the detection system (or the sample). The picture of the third embodiment is not shown, and therefore, will be described with reference to FIG. 3.

A sample (small animal) 10 placed at the center is held by one holder, and all other elements, such as mirrors, light sources, detector, and lenses are attached to another holding system different from the holder. The holding system is rotatably moved relative to the sample 10. For example, in a case where the sample 10 is observed from five evenly spaced directions, the holding system may be designed so as to be able to rotate 360°/5 (72°) relative to the sample 10. In this case, when the sample 10 is observed, for example, 6 times every 12° (72° divided by 6 equals 12°), images observed from 30 evenly spaced directions covering 360° can be obtained. It is not necessary to relatively rotate the sample 10 or the holding system 360°. The sample 10 or the holding system is relatively rotated by a relatively small angle because a rotation of 180° or 360° of a sample puts a heavy burden on a small animal as the sample, and it is difficult for the holder to even hold the sample. In addition, a rotation of 360° of the holding system complicates the handling of cables and the mechanical structure of the image acquiring device. However, as described above, a gentle rotation of the holder holding the sample 10 through an angle of, for example, one-fifth of 360° (72°) does not put a heavy burden on the small animal, and a rotation of the holding system through an angle of 72° is not difficult, either. Such a method used in the third embodiment, that is, a method in which the sample is observed from multiple directions evenly spaced with a smaller pitch such as a fraction of a pitch between the mirrors can be relatively easily achieved and is also useful.

The advantages of the third embodiment can be summarized as follows:

1) A plurality of images (e.g., 5 images) can be picked up at the same time, and therefore, the speed of observation is X times higher (X is the number of images picked up at the same time and is, for example, 5) even though the observation is performed in a time-division manner.

2) The angle of rotation of a sample (or a detector) is small, that is, at most one-fifth of 360°, and therefore, the structure of the image acquiring device can be simplified.

1. A living body image acquiring device comprising:
one two-dimensional detector for picking up an image of light emitted from a living body sample placed on a sample holder;
an image display device for displaying an image picked up by the two-dimensional detector;
a light guide optical system for observing the sample placed on the sample holder from multiple directions and guiding images of light emitted from the sample in different directions to the two-dimensional detector; and
one main image formation lens provided between the two-dimensional detector and the light guide optical system to form a plurality of images guided by the light guide optical system on the two-dimensional detector.

2. The living body image acquiring device according to claim 1,
wherein the light emitted from the sample is light emitted from the sample irradiated with excitation light or light emitted from the sample itself without irradiation with excitation light.

3. The living body image acquiring device according to claim 1,
wherein the light guide optical system includes a multi-reflector assembly having two or more reflectors for reflecting images of a sample observed from different directions and guiding the images to the two-dimensional detector.

4. The living body image acquiring device according to claim 1,
wherein the light guide optical system includes light paths different in light path length from the sample to the main image formation lens, and
wherein at least one light path of the light guide optical system has an auxiliary image formation lens for correcting, according to a light path length difference, an image formed on the two-dimensional detector by the main image formation lens.

5. The living body image acquiring device according to claim 4,
wherein the auxiliary image formation lens is one of a plurality of lenses each provided on the light paths of the light guide optical system respectively and constitutes a mosaic lens for different fields of view.

6. The living body image acquiring device according to claim 1,
wherein the image display device displays images formed on the two-dimensional detector after correction for a size difference resulting from a difference in light path length among the light paths of the light guide optical system.

7. The living body image acquiring device according to claim 1,
wherein the image display device displays images obtained by changing the orientation and sequence of images formed on the two-dimensional detector.

8. The living body image acquiring device according to claim 1,
wherein the light guide optical system allows the sample placed on the sample holder to be observed from four or more evenly spaced directions covering 360° around the sample.

9. The living body image acquiring device according to claim 3,
wherein the main image formation lens and the two-dimensional detector are placed in one direction perpendicular to the axial direction of the sample and each of the reflectors of the light guide optical system has a plane containing a straight line parallel to the axial direction of the sample as a reflection plane.

10. The living body image acquiring device according to claim 3,
wherein the main image formation lens and the two-dimensional detector are placed on an extended line of the axis of the sample, and the reflectors are arranged so that principal rays emitted from the sample in different directions lie in n evenly divided planes (n is an integer of 3 or more) of which the central axis is the axis of the sample.

11. The living body image acquiring device according to claim 1, further comprising a device for controlling image pickup operation,
wherein the sample is observed from n evenly spaced directions and the controlling device rotates the detector and the image formation lens relative to the sample in increments of an angle of 1/(n×m) of 360° (m is an integer of 2 or more) around the sample to perform an operation of acquiring images of the sample observed from n evenly spaced directions m times every 1/(n×m) of 360-degree rotation so that images observed from n×m evenly spaced directions covering 360° are acquired.

12. The living body image acquiring device according to claim 2, which acquires a fluorescence image as an image of the light emitted from the sample,
further comprising an excitation optical system for irradiating the sample with excitation light to generate fluorescence, the excitation optical system being placed in a space between light paths of the light guide optical system

13. The living body image acquiring device according to claim 12,
wherein the excitation optical system includes, as excitation light sources, light-emitting devices each having a laser diode or a light-emitting diode, and the irradiation direction of a sample with excitation light is changed by changing the lighting on/off pattern of the light-emitting devices.

14. The living body image acquiring device according to claim 13,
wherein each of the excitation light sources of the excitation optical system has two or more light-emitting devices emitting light of different wavelengths, and each of the light-emitting devices has an interference filter selected according to the wavelength of light emitted from the light-emitting device to remove an unnecessary wavelength component, and the wavelength of excitation light is changed by changing the lighting on/off pattern of the light-emitting devices.
